(19) United States
(12) Patent Application Publication
(10) Pub. No.: US 2026/0019521 A1
(43) Pub. Date: Jan. 15, 2026

(54) IMAGE PROCESSING DEVICE, IMAGE PROCESSING METHOD, PROGRAM, AND RECORDING MEDIUM

(71) Applicant: FUJIFILM Corporation, Tokyo (JP)

(72) Inventors: Yuma KOMIYA, Saitama-shi (JP); Kei Yamaji, Saitama-shi (JP); Kazuma Tsukagoshi, Saitama-shi (JP); Kazuki Oshima, Saitama-shi (JP)

(73) Assignee: FUJIFILM Corporation, Tokyo (JP)

(21) Appl. No.: 19/327,505

(22) Filed: Sep. 12, 2025

Related U.S. Application Data
(63) Continuation of application No. PCT/JP2024/007678, filed on Mar. 1, 2024.

(30) Foreign Application Priority Data
Mar. 30, 2023 (JP) 2023-055754

(51) Int. Cl. H04N 1/32; H04N 1/00

(52) U.S. Cl. CPC H04N 1/32149; H04N 1/00334; H04N 1/00363; H04N 2201/3269

(57) ABSTRACT

Provided are an image processing device, an image processing method, a program, and a recording medium that can prompt a user to use an image including a code region.

An image processing device according to one embodiment of the present invention includes a processor configured to: acquire a first image including a code region; acquire code information from the code region; and change the code information in response to an operation by a user.

### CROSS-REFERENCE TO RELATED APPLICATIONS

This application is a Continuation of PCT International Application No. PCT/JP2024/007678 filed on Mar. 1, 2024, which claims priority under 35 U.S.C. § 119 (a) to Japanese Patent Application No. 2023-055754 filed on Mar. 30, 2023. The above applications are hereby expressly incorporated by reference, in their entirety, into the present application.

### BACKGROUND OF THE INVENTION

### 1. Field of the Invention

Embodiments of the present invention relate to an image processing device, an image processing method, a program, and a recording medium.

### 2. Description of the Related Art

A technique of reading a code region from an image including a code region such as a two-dimensional barcode and a printed matter on which the image is printed has already been developed, and examples thereof include a technique disclosed in JP2013-98682A.

An image processing system disclosed in JP2013-98682A comprises reading means for reading a marker from a printed matter on which the marker is printed, connection means for connecting to a server based on information indicated by the marker read by the reading means, and acquisition means for acquiring image data for displaying an image that is not masked by the marker, from the server connected by the connection means.

### SUMMARY OF THE INVENTION

Companies and the like that provide services that can be accessed through code regions would like as many users as possible to access websites thereof and the like through the code regions and use services thereof. For this reason, it is necessary to prompt as many users as possible to use the image including the code region.

One embodiment of the present invention has been made in view of the above circumstances, and an object of the present invention is to provide an image processing device, an image processing method, a program, and a recording medium that can prompt a user to use an image including a code region.

In order to achieve the above-described object, an aspect of the present invention provides an image processing device comprising: a processor configured to: acquire a first image including a code region; acquire code information from the code region; and change the code information in response to an operation by a user.

In addition, the code information may be changed in accordance with the operation.

In addition, the operation may be an operation of scanning a subject included in the first image.

In addition, the operation may be an operation of printing the first image.

In addition, the operation may be an operation of transmitting the first image to another user.

In addition, the code information may include an execution count indicating how many times the code information has been changed to date. In addition, the processor may be configured to: update the execution count included in the code information in a case of changing the code information.

In addition, the processor may be configured to: add at least one of information related to a device that has received the operation or information related to the user to the code information in a case of changing the code information.

In addition, the processor may be configured to: generate a third image including a second image included in the first image and the code region based on the changed code information.

In addition, the code information may include storage destination information for specifying a storage destination of a fourth image corresponding to a second image included in the first image. In addition, the processor may be configured to: acquire the fourth image stored in the storage destination, based on the storage destination information.

In addition, the processor may be configured to: generate a third image including the fourth image and the code region based on the changed code information.

In addition, the code information may include history information related to an execution history in which the code information has been changed to date.

In addition, the history information may include at least one of an execution time at which the code information has been changed, a content of the operation by the user, or a device that has received the operation by the user.

In addition, the processor may be configured to: transmit related information associated with the first image.

In addition, the processor may be configured to: specify an execution count indicating how many times the code information has been changed to date, based on the code information. In addition, the processor may be configured to: transmit, as the related information, provision data corresponding to the execution count.

In addition, the processor may be configured to: restrict transmission of the related information in a case in which the execution count is equal to or greater than a first set value.

In addition, the processor may be configured to: specify an execution count indicating how many times the code information has been changed to date, based on the code information. In addition, the processor may be configured to: restrict change of the code information in a case in which the execution count is equal to or greater than a second set value.

In addition, the processor may be configured to: specify use conditions in a case in which the user executes the operation to use the first image. In addition, the processor may be configured to: transmit provision data that is associated with the first image and that corresponds to the use conditions.

In order to achieve the above-described object, another aspect of the present invention provides an image processing method executed by a processor, the image processing method comprising: a process of acquiring a first image including a code region; a process of acquiring code information from the code region; and a process of changing the code information in response to an operation by a user.

Further, still another aspect of the present invention realizes a program causing a computer to execute each process included in the image processing method described above.

Further, still another aspect of the present invention realizes a computer-readable recording medium on which a program causing a computer to execute each process included in the image processing method described above is recorded.

According to the aspects of the present invention, it is possible to provide the image processing device, the image processing method, the program, and the recording medium that can prompt the user to use the image including the code region.

### BRIEF DESCRIPTION OF THE DRAWINGS

FIG. 1 is a diagram showing an example of an overview of present image processing according to one embodiment of the present invention.

FIG. 2 is a diagram showing an example of an overview of the present image processing according to one embodiment of the present invention.

FIG. 3 is a diagram showing an example of an overview of the present image processing according to one embodiment of the present invention.

FIG. 4 is a diagram showing an example of an overview of the present image processing according to one embodiment of the present invention.

FIG. 5 is a diagram showing history information recorded in code information.

FIG. 6 is a diagram showing a configuration example of an image processing system including an image processing device according to one embodiment of the present invention.

FIG. 7 is a diagram showing a function of the image processing device according to one embodiment of the present invention.

FIG. 8 is a diagram showing a procedure of an image processing flow according to one embodiment of the present invention.

### DESCRIPTION OF THE PREFERRED EMBODIMENTS

Specific embodiments of the present invention will be described with reference to the accompanying drawings. However, the embodiments described below are merely examples for ease of understanding of the present invention, and are not intended to limit the present invention. Moreover, the present invention can be changed or improved from the embodiments described below without departing from the gist of the present invention. In addition, the present invention also includes an equivalent thereof.

In the present specification, the concept of “apparatus” includes a single apparatus that exerts a specific function and includes a combination of a plurality of apparatuses that are present independently and that are distributed but operate together (cooperate) to exert a specific function.

Moreover, in the present specification, an “image” means image data unless otherwise noted. Examples of the image data may include image data of a non-reversible compression such as a joint photographic experts group (JPEG) format, image data of a reversible compression such as a graphics interchange format (GIF) or a portable network graphics (PNG) format, and three-dimensional image data used on a web browser such as a virtual reality modeling language (VRML) format.

In addition, the image data may include accessory information indicating information such as a file name, an imaging date and time, and an imaging place.

Further, in the present specification, the “user” means a user who uses the image processing device according to the embodiment of the present invention. Using the image processing device is to use a function of the image processing device, and includes not only a direct operation of the image processing device but also the use of the function of the image processing device through a device (for example, a user terminal) capable of communicating with the image processing device.

### <<Overview of Present Image Processing>>

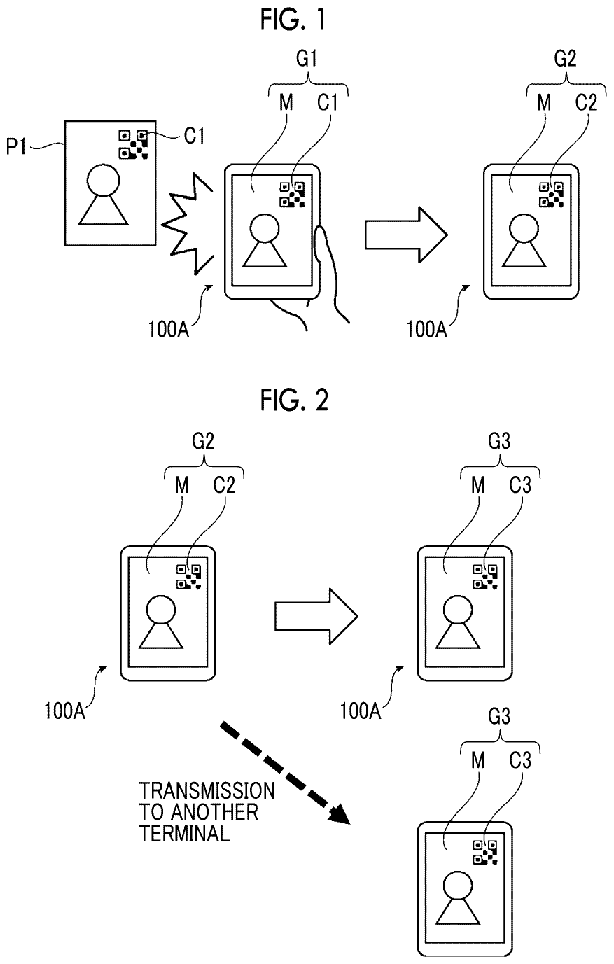

Image processing (hereinafter, the present image processing) executed using the image processing device and the image processing method according to one embodiment of the present invention will be described with reference to FIGS. 1 to 5.

In the present image processing, code information is acquired from a code region included in an image, and a process of changing the code information is executed in response to an operation by a user. For example, as shown in FIG. 1, a printed matter P1 on which the code information is printed is imaged to acquire an image (captured image) in which the printed matter P1 is a subject, and a region in which a printed portion of the code information is captured in the image is extracted as the code region. Then, the extracted code region is analyzed to acquire the code information, and the code information is overwritten such that history information indicating that an operation of imaging the printed matter P1 is executed once is added to the acquired code information. Such a series of processes corresponds to the present image processing.

The “code region” means a barcode or a two-dimensional code and is, for example, a QR code (registered trademark).

The “code information” includes link information to a transition destination, for example, a uniform resource locator (URL) or a uniform resource identifier (URI) including the URL, and history information related to an execution history in which the code information has been changed to date.

The “operation by the user” refers to, for example, an operation of scanning the printed matter including the code region as the subject, an operation of printing the image including the code region, an operation of transmitting the image including the code region to another user, or the like.

The “changing the code information in response to the operation by the user” includes a case in which the code information is changed in association with the operation by the user and a case in which the code information is changed in accordance with the operation by the user.

The “changing the code information in association with the operation by the user” is triggered by the operation by the user and includes a case in which a waiting time is provided from the operation by the user to the change of the code information or a case in which an operation of another user is also required in changing the code information.

The “changing the code information in accordance with the operation by the user” is triggered by the operation by the user and includes a case in which the series of processes from the operation by the user to the change of the code information is smoothly executed with the operation by the user as a trigger. For example, as shown in FIG. 1, a case in which the series of processes from the operation of scanning the printed matter including the code region as the subject to the change of the code information is smoothly executed with the scan operation as a trigger is included.

The “history information” includes at least one of an execution count indicating how many times the code information has been changed to date, an execution time at which the code information has been changed, a content of the operation by the user, which is a trigger for the change of the code information, a device that has received the operation, or information related to the user who has executed the operation.

The “execution time” may indicate a strict date and time of execution, or may indicate a rough period (periodic period) such as day and night or a season.

The “content of the operation by the user” includes scanning the subject, printing the image, transmitting the image to another user, and the like.

The “subject” means the printed matter including the code region. In a case in which an image that does not include a printed matter including a code region is captured, the image may be treated as simple imaging, notification may be provided to the user to prompt the user to capture the printed matter including the code region, or any of these operations may be executed.

The “printed matter” means, for example, a photograph obtained by developing a latent image recorded on a medium such as an instant film, or a printed matter obtained by printing image data on a paper medium by a printer.

The “scanning the subject” is a series of acts of imaging a printed matter with a user terminal having a camera function and acquiring an image related to the printed matter.

The “device that has received the operation by the user” includes, for example, a user terminal that scans a printed matter, a printer that prints an image, a user terminal that issues an instruction for the printing, a user terminal that transmits an image, a user terminal that receives an image, and the like.

The “information related to the user” is identification information of the user in the present image processing, and specifically, is a user name or the like registered by the user who uses the present image processing through an application program for image processing (hereinafter, an image processing application). The image processing application is downloaded from a predetermined site, and is installed on the user terminal.

The “user terminal” is a computer used by the user and is, specifically, composed of a smart device such as a smartphone, a tablet terminal, a laptop personal computer (PC), or the like. The user terminal comprises a processor, a memory, and a communication interface.

Hereinafter, four examples in which the present image processing is executed will be described with reference to FIGS. 1 to 5. In the four examples described below, the operations of the user that are the triggers for executing the present image processing are different from each other.

(Case in which Scan Operation is Trigger)

In the example shown in FIG. 1, the process of changing the code information is executed with the operation of scanning the printed matter P1 as the subject as a trigger.

Specifically, first, a user A visits a venue of an event or the like and obtains the printed matter P1 including a code region C1 at the venue.

The image (excluding the code region C1) printed on the printed matter P1 is, for example, an image corresponding to the event, and specifically, may be an image obtained by capturing a person, a character, a product, a background, or the like appearing in the event, or may be an image drawn using computer graphics (CG) and the like.

The code region C1 included in the printed matter P1 is disposed at any position of the region of the printed matter P1, and, in the example shown in FIG. 1, the code region C1 is disposed on an upper right side of the printed matter P1. That is, the printed matter P1 is assigned with unique code information, and the code region C1 indicating the code information is printed on the printed matter P1. The image indicated by the code region C1 is an image of characters or symbols representing the code information, and the code information includes link information to a predetermined website.

The “link information to a predetermined website” is, for example, a link to a predetermined website prepared by a company or the like that holds the event. The user can access the predetermined website by reading the code region C1 using, for example, a reading function provided in the user terminal.

The user A who has obtained the printed matter P1 activates the image processing application that is installed in advance on his/her own terminal 100A, and switches a display screen of the terminal 100A to an imaging screen through a predetermined operation. The user A switches the display screen to the imaging screen and scans (captures) the printed matter P1 using the camera function of the terminal 100A.

It is assumed that the user A registers a user name (A) and a his/her own terminal's name (terminal 100A) in the image processing application in a case in which the image processing application is installed in the terminal 100A.

After capturing the printed matter P1, the user A executes a predetermined operation in accordance with an instruction of the image processing application, and switches the display screen of the terminal 100A to a selection screen for selecting a target image. For example, in a case in which the image processing application displays a message “The printed matter has been detected. Would you like to switch to the image selection screen?”, the user A switches the display screen of the terminal 100A to the selection screen. The image processing application may automatically switch to the selection screen in a case in which the fact that the printed matter P1 is imaged is detected. On the selection screen, an image group composed of images captured by the present image processing or images generated by the present image processing is displayed, and the user A selects the target image from the image group. In the example shown in FIG. 1, the user A selects a most recently captured image, that is, an image G1 obtained by scanning the printed matter P1, as the target image. The image, which is actually obtained by imaging the printed matter P1 for the first time, is an image including the image G1 and the background at the time of imaging, but the image G1 can be obtained by using a known technique of specifying a substantially rectangular region and shaping the substantially rectangular region into a rectangle. In the present embodiment, the series of acts from imaging the printed matter P1 to obtaining the image G1 is expressed as “scanning the printed matter to obtain the image”. As a result, the image G1 is acquired as a first image, and the present image processing is executed.

The image G1 includes the code region C1 and an image M (corresponding to a second image) consisting of regions other than the code region C1.

The image M includes regions excluding the code region C1 in the region corresponding to the printed matter P1 in the image G1. That is, the image M occupies most of the image G1, and is also referred to as a so-called main image. The image M need not be the main image, and the code region C1 may be sufficiently larger than the image M.

By acquiring the image G1 as the first image, the code information is acquired from the code region C1 included in the image G1, and the process of changing the code information is executed.

An execution count indicating how many times the code information has been changed to date is recorded as zero in the code information acquired from the code region C1. By executing the process of changing the code information, the execution count included in the changed code information is updated. Specifically, the execution count indicating how many times the user A has executed the scan operation by the terminal 100A is updated from zero to one. The code information also records an execution time at which the process of changing the code information is executed.

After the code information is changed, a code region C2 is generated based on the changed code information. Thereafter, the image G2 (corresponding to a third image) is generated by using the code region C2 and the image M acquired from the image G1.

The image G2 generated in this way is provided to the user A and is displayed on the display screen of the terminal 100A in accordance with use conditions of the image.

Specifically, the “use conditions of the image” mean an image quality of the terminal 100A, a size of the display screen of the terminal 100A, and the like, and the “image quality” means a screen resolution of the display screen of the terminal 100A and a display resolution that can be handled by the processor of the terminal 100A.

The image G2 is provided to the user A, and related information associated with the first image is transmitted to a predetermined transmission destination. The predetermined transmission destination is, for example, a user related to the first image, that is, a user who uses the first image or an image that is derived from the first image. In the example shown in FIG. 1, for example, the user A is the predetermined transmission destination.

It should be noted that the related information may be transmitted to at least any of a plurality of users using the first image or the image that is derived from the first image.

The related information is stored in a storage destination prepared by a company or the like that provides the present image processing service, for example, a database server 11 described later.

The related information may be simple notification or may be provision data.

The “notification” is, for example, information transmitted to all users who use the first image or the image that is derived from the first image, and is advertisement and promotion related to the first image. Alternatively, information indicating that the user can obtain the “provision data”, which will be described later, is also included in the “notification”. Examples thereof include information for notifying only that “The benefit will be available”. In such a case, it is not necessary to include the content of the provision data itself. The user can know the content of the provision data only by opening the notification.

The “provision data” is, for example, a benefit or the like, and specifically, an image, a coupon, or the like.

In addition, the provision data may be provision data corresponding to the execution count indicating how many times the code information has been changed. For example, the ranks may be assigned to a plurality of provision data in advance, and the provision data having a higher rank among the plurality of provision data may be provided as the execution count is larger.

The execution count may be an execution count counted for each user (or each user terminal), or may be a cumulative execution count by all users (or user terminals) related to the first image.

The provision data may be, for example, image data of a person or a character different from a person or a character displayed on the printed matter P1. In addition, the provision data may be image data of the same person or character as the person or character displayed on the printed matter P1, and may be data of an image in which a facial expression, clothing, or the like of the person or character or the background is different. In addition, the provision data may be image data with a message in which a message is added to the image of the person or the character.

In a case in which the execution count indicating how many times the code information has been changed is equal to or greater than a set value (corresponding to a first set value), the transmission of the related information may be restricted. For example, in a case in which the execution count is equal to or greater than the first set value, the provision data may be stopped from being distributed.

The execution count may be the execution count counted for each user (or each user terminal), or may be the cumulative execution count by all users (or user terminals) related to the first image.

The first set value can be set to any natural number, and, for example, the first set value may be set to a value corresponding to the content of the service in which the present image processing is used.

As described above, the image G2 and the related information are provided to the user A, and then the present image processing ends.

(Case in which Transmission Operation is Trigger)

In the example shown in FIG. 2, the process of changing the code information is executed with the operation of transmitting the first image to another user by the user A as a trigger.

Specifically, first, the user A activates the image processing application installed in advance on his/her own terminal 100A, and switches the display screen of the terminal 100A to a selection screen for selecting an image to be transmitted to another user, through a predetermined operation.

On the selection screen, the image group composed of the images captured by the present image processing or the images generated by the present image processing is displayed, and the user A selects the target image from the image group. In the example shown in FIG. 2, the user A selects the image generated by the present image processing in the example shown in FIG. 1, that is, the image G2, as an transmission image. As a result, the image G2 is acquired as the first image, and the present image processing is executed.

By acquiring the image G2 as the first image, the code information is acquired from the code region C2 included in the image G2, and the process of changing the code information is executed.

In the code information acquired from the code region C2, as the execution count indicating how many times the code information has been changed to date, information indicating that the execution count indicating how many times the user A has executed the scan operation on the terminal 100A is one is recorded. By executing the process of changing the code information, the execution count included in the changed code information is updated. Specifically, the execution count indicating how many times the user A has executed the transmission operation by the terminal 100A is updated from zero to one. That is, in the changed code information, information indicating that the execution count indicating how many times the user A has executed the scan operation on the terminal 100A is one and information indicating that the execution count indicating how many times the user A has executed the transmission operation on the terminal 100A is one are recorded. In addition, the code information also records the execution time at which the process of changing the code information is executed.

After the code information is changed, a code region C3 is generated based on the changed code information. Thereafter, an image G3 (corresponding to the third image) is generated by using the code region C3 and the image M acquired from the image G2.

The image G3 generated in this way is provided to the user A and a user of another terminal, respectively, and is displayed on the display screen of each terminal in accordance with the use conditions of the image described above.

The image G3 is provided to the user A and the user of the other terminal, and the related information associated with the first image is transmitted to the predetermined transmission destination. The predetermined transmission destination is, for example, the user related to the first image, that is, the user who uses the first image or the image that is derived from the first image. In the example shown in FIG. 2, for example, the user A and the user of the other terminal are the predetermined transmission destinations.

As described above, the image G3 is provided to the user A and the user of the other terminal, the related information is provided to the user related to the first image, and then the present image processing ends.

(Case in which Print Operation is Trigger)

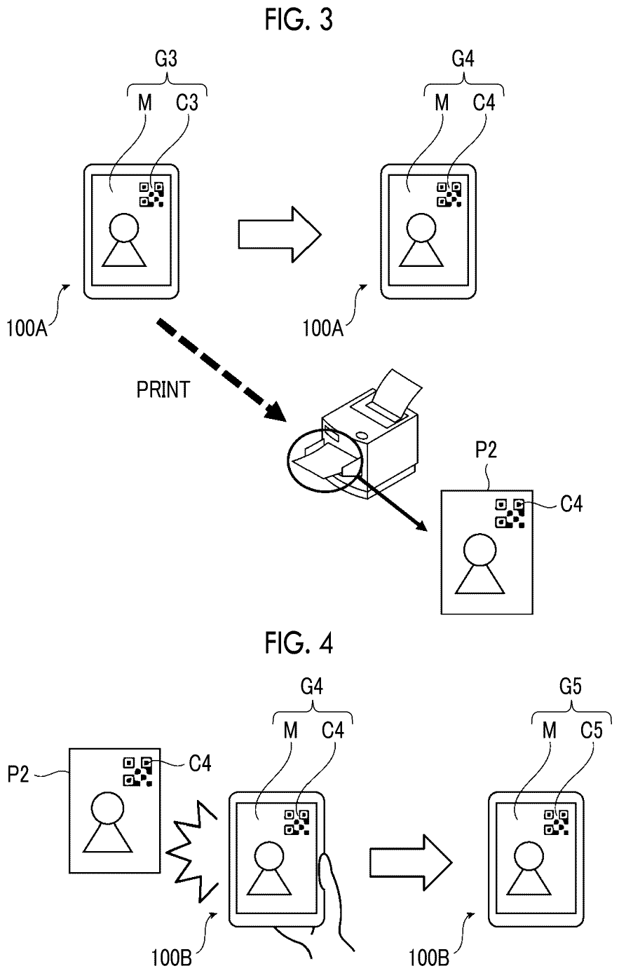

In the example shown in FIG. 3, the process of changing the code information is executed with the operation of printing the first image as a trigger.

Specifically, first, the user A activates the image processing application installed in advance on his/her own terminal 100A, and switches the display screen of the terminal 100A to a selection screen for selecting an image to be printed, through a predetermined operation.

On the selection screen, the image group composed of the images captured by the present image processing or the images generated by the present image processing is displayed, and the user A selects the target image from the image group. In the example shown in FIG. 3, the image generated by the present image processing in the example shown in FIG. 2, that is, the image G3 is selected, and a print button (not shown) is pressed. As a result, the image G3 is acquired as the first image, and the present image processing is executed.

By executing the operation of printing the image G3, the code information is acquired from the code region C3 included in the image G3, and the process of changing the code information is executed.

In the code information acquired from the code region C3, as the execution count indicating how many times the code information has been changed to date, information indicating that the execution count indicating how many times the user A has executed the scan operation on the terminal 100A is one and information indicating that the execution count indicating how many times the user A has executed the transmission operation on the terminal 100A is one are recorded. By executing the process of changing the code information, the execution count included in the changed code information is updated. Specifically, the execution count indicating how many times the user A has executed the print operation by the terminal 100A is updated from zero to one. That is, in the changed code information, information indicating that the execution count indicating how many times the user A has executed the scan operation on the terminal 100A is one, information indicating that the execution count indicating how many times the user A has executed the transmission operation on the terminal 100A is one, and information indicating that the execution count indicating how many times the user A has executed the print operation on the terminal 100A is one are recorded. In addition, the code information also records the execution time at which the process of changing the code information is executed.

After the code information is changed, a code region C4 is generated based on the changed code information. Thereafter, an image G4 (corresponding to the third image) is generated by using the code region C4 and the image M acquired from the image G3.

The image G4 generated in this way is provided to the user A and is displayed on a display screen of a user terminal 100 in accordance with the use conditions of the image. In addition, the image G4 is transmitted to a printer and is output as a display image of a printed matter P2 in accordance with the use conditions of the image. The use conditions of the image include a size of the printed matter P2 in addition to the image quality of the terminal 100A, the size of the display screen of the terminal 100A, and the like.

The image G4 is provided to the user A, and the related information associated with the first image is transmitted to a predetermined transmission destination. The predetermined transmission destination is, for example, the user related to the first image, that is, all users who use the first image or the image that is derived from the first image. In the example shown in FIG. 3, the user A and the user of the other terminal that has acquired the image G3 in the example shown in FIG. 2 are the predetermined transmission destinations.

As described above, the image G4 is provided to the user A and is output as the printed matter P2, the related information is provided to the user related to the first image, and then the present image processing ends.

(Case in which Scan Operation by Another Terminal is Trigger)

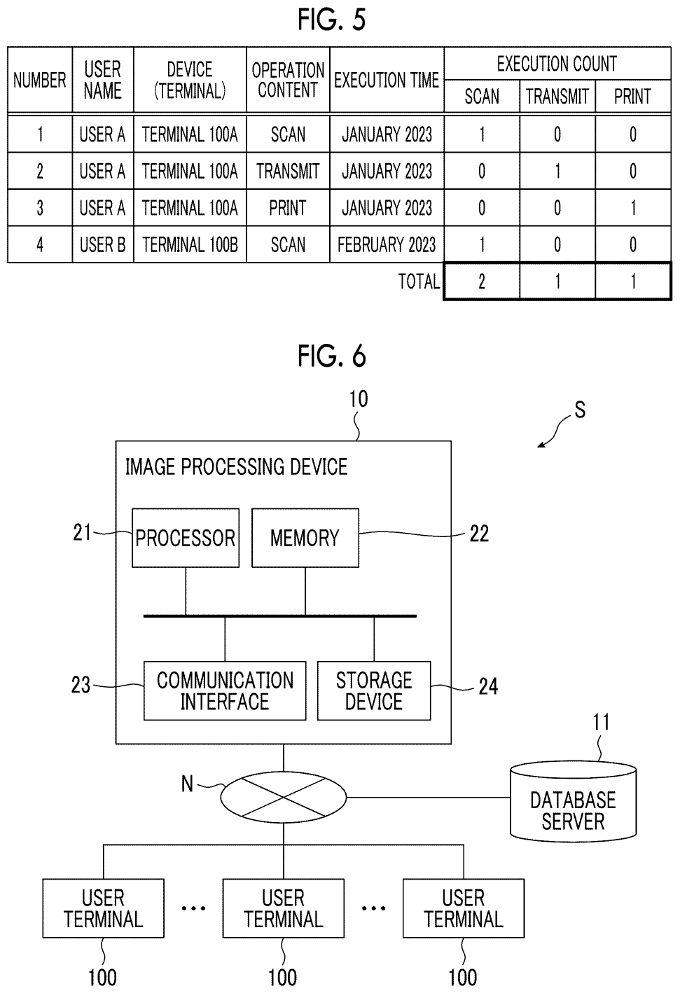

In the examples shown in FIGS. 4 and 5, a user B different from the user A executes the scan operation of the printed matter using his/her own terminal 100B. More specifically, the process of changing the code information is executed with the operation of scanning the printed matter P2 as the subject by the user B as a trigger.

Specifically, first, the user B receives the printed matter P2 printed in the example shown in FIG. 3 from the user A. The user B who has received the printed matter P2 activates the image processing application installed in advance on his/her own terminal 100B, and switches a display screen of the terminal 100B to an imaging screen through a predetermined operation. The user B switches the display screen to the imaging screen and scans (captures) the printed matter P2 using the camera function of the terminal 100B.

It is assumed that the user B registers a user name (B) and a his/her own terminal's name (terminal 100B) in the image processing application in a case in which the image processing application is installed in the terminal 100B.

After capturing the printed matter P2, the user B executes a predetermined operation in accordance with an instruction of the image processing application, and switches the display screen of the terminal 100B to a selection screen for a target image. On the selection screen, the image group composed of the images captured by the present image processing or the images generated by the present image processing is displayed, and the user B selects the target image from the image group. In the example shown in FIG. 4, the user B selects a most recently captured image, that is, an image G4 obtained by scanning the printed matter P2, as the target image. As a result, the image G4 is acquired as the first image, and the present image processing is executed.

By acquiring the image G4, the code information is acquired from the code region C4 included in the image G4, and the process of changing the code information is executed.

The code information acquired from the code region C4 includes the execution count indicating how many times the code information has been changed to date. More specifically, the code information of the code region C4 includes information indicating that the execution count indicating how many times the user A has executed the scan operation on the terminal 100A is one, information indicating that the execution count indicating how many times the user A has executed the transmission operation on the terminal 100A is one, and information indicating that the execution count indicating how many times the user A has executed the print operation on the terminal 100A is one.

By executing the process of changing the code information, the execution count included in the changed code information is updated. Specifically, the execution count indicating how many times the user B has executed the scan operation by the terminal 100B is updated from zero to one. That is, in the changed code information, information indicating that the execution count indicating how many times the user A has executed the scan operation on the terminal 100A is one, information indicating that the execution count indicating how many times the user A has executed the transmission operation on the terminal 100A is one, information indicating that the execution count indicating how many times the user A has executed the print operation on the terminal 100A is one, information indicating that the execution count indicating the user B has executed the scan operation on the terminal 100B is one are recorded. The code information also records the execution time at which the process of changing the code information is executed.

More specifically, as shown in FIG. 5, in the changed code information, as the history information, the information (user A and user B) related to the user who has executed the operation that is a trigger for changing the code information, the device (terminal 100A and terminal 100B) that has received the operation, the content of the operation (scan operation, transmission operation, and print operation), the execution time at which the code information has been changed, and the execution count indicating how many times the code information has been changed to date are recorded.

After the code information is changed, a code region C5 is generated based on the changed code information. Thereafter, an image G5 (corresponding to the third image) is generated by using the code region C5 and the image M acquired from the image G4.

The image G5 generated in this way is provided to the user B and is displayed on the display screen of the terminal 100B in accordance with use conditions of the image.

The image G5 is provided to the user B, and the related information associated with the first image is transmitted to a predetermined transmission destination. The predetermined transmission destination is, for example, a user related to the first image, that is, the user who uses the first image or the image that is derived from the first image. In the example shown in FIG. 4, for example, the user A, the other terminal to which the image G3 is transmitted, and the user B are the predetermined transmission destinations.

In addition, the provision data with a higher rank may be provided to the user whose time of using the first image or the image that is derived from the first image is earlier. Specifically, as shown in FIG. 5, the provision data having a higher rank may be provided to the user A whose execution time is earlier than the user B with reference to the execution time at which the code information has been changed. That is, by referring to the execution time, the users (or the user terminals) can be classified for each time when the first image or the image that is derived from the first image is used. Stated another way, the users (or the user terminals) can be classified by generation.

As described above, the image G5 is provided to the user B, the related information is provided to the user related to the first image, and then the present image processing ends.

In addition, the changed code information may be stored in the database server 11 or a device such as a user terminal, which will be described later. Meanwhile, from the viewpoint of protecting the personal information, the changed code information may be recorded only in the code region.

In addition, in a case in which the execution count indicating how many times the code information has been changed is equal to or greater than a set value (corresponding to a second set value), the change of the code information may be restricted.

The execution count may be the execution count counted for each user (or each user terminal), or may be the cumulative execution count by all users (or user terminals) related to the first image.

For example, in a case in which the execution count is equal to or greater than the second set value, even though the operation of scanning the printed matter P2 as the subject is executed thereafter, only the image G4 including the code region C4 may be acquired, and the image G5 including the code region C5 may not be generated.

The second set value can be set to any natural number, and, for example, the first set value may be set to a value corresponding to the content of the service in which the present image processing is used.

In the above description, the third image is generated by the image M (corresponding to the second image) included in the first image, and the code region based on the changed code information. However, the present invention is not limited to this, and the third image may be generated using a fourth image corresponding to the second image instead of the image M.

More specifically, the fourth image is stored in, for example, a storage destination prepared by a company or the like that provides the present image processing service, for example, the database server 11 described later. The code information based on the code region includes the storage destination information for specifying the storage destination of the fourth image, and the fourth image stored in the database server 11 is acquired based on the storage destination information.

The fourth image may be, for example, an original image used in a case in which the printed matter P1 is printed. Here, the fourth image, which is the original image, is usually an image of which the image quality is higher than the image quality of the image M obtained by scanning the printed matter P1. Therefore, the third image including the fourth image is provided as an image of which the image quality is higher than the image quality of the third image including the image M.

In addition, the fourth image may be provided in accordance with the execution count indicating how many times the code information has been changed to date. For example, ranks (rarity and the like) may be assigned to a plurality of images in advance, and an image having a higher rank among the plurality of images may be provided as the fourth image as the execution count is larger.

### <<Configuration Example of Image Processing System According to One Embodiment of Present Invention>>

A configuration of an image processing system (hereinafter, referred to as “image processing system S”) including the image processing device according to one embodiment of the present invention will be described with reference to FIG. 6.

As shown in FIG. 6, the image processing system S includes the image processing device 10, a plurality of user terminals 100, and the database server 11.

The database server 11 may be configured as a part of the image processing device 10.

The image processing device 10 is configured of a server computer. The image processing device 10 may be configured by one server computer or may be configured by a plurality of server computers that are distributed in parallel. In addition, the server computer constituting the image processing device 10 may be a server computer for an application service provider (ASP), software as a service (SaaS), platform as a service (PaaS), or infrastructure as a service (IaaS). In a case in which necessary information is input to the user terminal 100, the above-described server computer executes various types of processing (operations) based on the input information, and an operation result is output on the user terminal 100 side. That is, the function of the server computer, which is the image processing device 10, can be used on the user terminal 100 side.

As shown in FIG. 6, the computer constituting the image processing device 10 includes a processor 21, a memory 22, a communication interface 23, and a storage device 24.

The processor 21 is configured by, for example, a central processing unit (CPU), a micro-processing unit (MPU), a micro controller unit (MCU), a graphics processing unit (GPU), a digital signal processor (DSP), a tensor processing unit (TPU), or an application-specific integrated circuit (ASIC).

The memory 22 is configured by, for example, a semiconductor memory, such as a read-only memory (ROM) and a random-access memory (RAM). The memory 22 stores a program (hereinafter, an image processing program) for executing the present image processing. The image processing program is a program causing the processor 21 to execute each process of the image processing method described below. The image processing program may be acquired by being read from a computer-readable recording medium, or may be acquired by being downloaded through a communication network, such as the Internet or an intranet.

The communication interface 23 may be configured by, for example, a network interface card or a communication interface board. The computer constituting the image processing device 10 is able to communicate with another device connected to the Internet, a mobile communication line, or the like via the communication interface 23.

The storage device 24 is configured by, for example, a flash memory, a hard disc drive (HDD), a solid state drive (SSD), a flexible disc (FD), a magneto-optical disc (MO disc), a compact disc (CD), a digital versatile disc (DVD), a secure digital card (SD card), a universal serial bus memory (USB memory), or the like. The storage device 24 may be built in a computer body constituting the image processing device 10 or may be externally mounted on the computer body.

As described above, the user terminal 100 is a computer used by the user, and specifically, is configured by a smart device such as a smartphone, a tablet terminal, a laptop PC, or the like.

The database server 11 is, for example, a cloud-based server prepared by a company that operates a service using the image processing device 10, specifically, a company that provides a service of the present image processing. The image processing device 10 is communicably connected to the database server 11 through a network N and can freely read out various types of data.

As described above, the related information, which is associated with the first image, is stored in the database server 11. As described above, the database server 11 stores the fourth image corresponding to the image M (corresponding to the second image) included in the first image. Further, the changed code information may be stored in the database server 11 as described above.

### <<Function of Image Processing Device According to One Embodiment of Present Invention>>

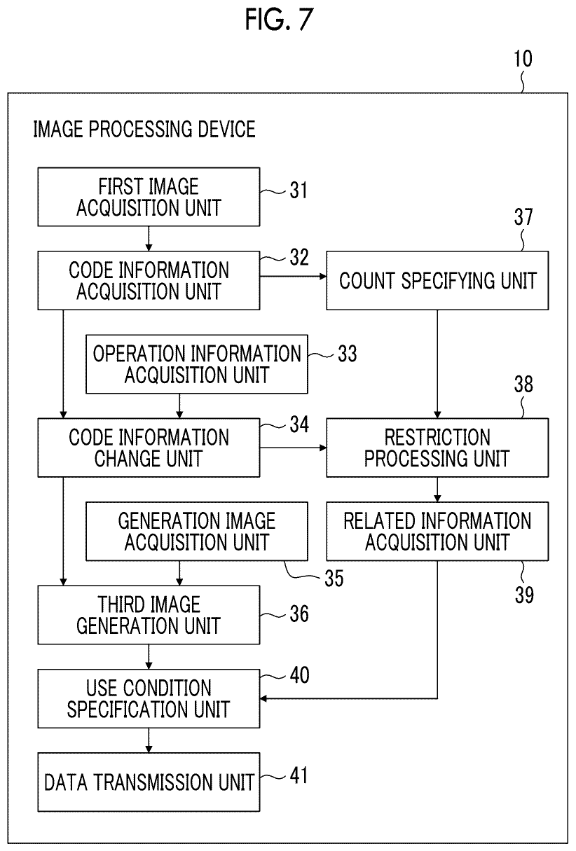

Next, a configuration of the image processing device 10 according to one embodiment of the present invention will be described again from the viewpoint of the functional aspects. As shown in FIG. 7, the image processing device 10 includes a first image acquisition unit 31, a code information acquisition unit 32, an operation information acquisition unit 33, a code information change unit 34, a generation image acquisition unit 35, a third image generation unit 36, a count specifying unit 37, a restriction processing unit 38, a related information acquisition unit 39, use condition specifying unit 40, and a data transmission unit 41.

These functional units are implemented by cooperation between a hardware device included in the computer constituting the image processing device 10 and the program (that is, software) installed in the computer.

Hereinafter, each of the functional units will be described.

### (First Image Acquisition Unit)

The first image acquisition unit 31 acquires the first image including the code region. The first image is acquired in response to the operation by the user, and more specifically, is acquired in accordance with the operation of scanning the subject, the operation of transmitting the image to another user, or the operation of printing the image. In the example shown in FIG. 1, the image G1 obtained by scanning (capturing) the printed matter P1 is acquired as the first image. In the example shown in FIG. 2, the image G2 in which the code region of the image G1 is changed is acquired as the first image. In the example shown in FIG. 3, the image G3 in which the code region of the image G2 is changed is acquired as the first image. In the examples shown in FIGS. 4 and 5, the image G4 in which the code region of the image G3 is changed is acquired as the first image.

### (Code Information Acquisition Unit)

The code information acquisition unit 32 acquires the code information from the code region. Stated another way, the code information acquisition unit 32 specifies the code information based on the code region in the first image. As described above, the code information includes the history information related to the execution history in which the code information has been changed to date, together with the link information to the predetermined website. As described above, the history information includes at least one of the execution count indicating how many times the code information has been changed to date, the execution time at which the code information has been changed, the content of the operation by the user, which is a trigger for the change of the code information, the device that has received the operation, or the information related to the user who has executed the operation.

### (Operation Information Acquisition Unit)

The operation information acquisition unit 33 acquires at least one of the information related to the operation that is a trigger for changing the code information, specifically, the information related to the content of the operation by the user, the device that has received the operation by the user, or the user who has executed the operation.

### (Code Information Change Unit)

The code information change unit 34 changes the code information in response to the operation by the user. As described above, the operation by the user includes the scan operation of the subject included in the first image, the operation of printing the first image, the operation of transmitting the first image to another user, and the like.

In a case of changing the code information, the code information change unit 34 updates at least one of the execution count included in the code information, the execution time at which the code information has been changed, the content of the operation by the user, which is a trigger for the change of the code information, the device that has received the operation, or the information related to the user who has executed the operation.

### (Generation Image Acquisition Unit)

The generation image acquisition unit 35 acquires the second image included in the first image as a generation image for the third image. The second image corresponds to the image M consisting of the regions other than the code region.

Alternatively, the generation image acquisition unit 35 may acquire the fourth image corresponding to the second image (that is, the image M) included in the first image as the generation image for the third image. The code information acquired from the code region includes the storage destination information for specifying the storage destination (for example, the database server 11) of the fourth image. The generation image acquisition unit 35 acquires the fourth image stored in the storage destination based on the storage destination information. As described above, the fourth image is, for example, an original image used in a case in which the printed matter P1 is printed. The fourth image may be provided in accordance with the execution count indicating how many times the code information has been changed to date, and the rank (rarity or the like) may be assigned to the plurality of images in advance, and the image with a higher rank among the plurality of images may be provided as the fourth image as the execution count is larger.

### (Third Image Generation Unit)

The third image generation unit 36 generates the third image including the second image acquired by the generation image acquisition unit 35 and the code region based on the code information changed by the code information change unit 34. In the examples shown in FIGS. 1 to 5, the third image generation unit 36 generates each of the image G2 including the image M and the code region C2, the image G3 including the image M and the code region C3, the image G4 including the image M and the code region C4, and the image G5 including the image M and the code region C5.

Alternatively, the third image generation unit 36 may generate the third image including the fourth image acquired by the generation image acquisition unit 35 and the code region based on the code information changed by the code information change unit 34.

### (Count Specifying Unit)

The count specifying unit 37 specifies the execution count indicating how many times the code information has been changed to date, based on the code information acquired by the code information acquisition unit 32. In the examples shown in FIGS. 1 to 5, the count specifying unit 37 specifies the execution count for each operation of the content, specifically, scan, print, and transmission for each device (the terminal 100A and the terminal 100B) that has received the operation by the user.

### (Restriction Processing Unit)

In a case in which the execution count specified by the count specifying unit 37 is a value equal to or greater than the first set value, the restriction processing unit 38 restricts the transmission of the related information. In addition, in a case in which the execution count specified by the count specifying unit 37 is a value equal to or greater than the second set value, the restriction processing unit 38 restricts the change of the code information.

Each set value can be set to any natural number as described above, but, for example, may be set to a value in accordance with the content of the service in which the present image processing is used.

The first set value and the second set value may be the same value, or may be different values.

### (Related Information Acquisition Unit)

The related information acquisition unit 39 acquires the related information associated with the first image. As described above, the related information may be the simple notification or may be the provision data.

The related information acquisition unit 39 acquires the provision data in a case in which the execution count is less than the first set value. In addition, the related information acquisition unit 39 may acquire the provision data corresponding to the execution count as the related information from among the plurality of provision data. For example, the related information acquisition unit 39 may rank the plurality of provision data in advance, and may provide the provision data having a higher rank among the plurality of provision data as the execution count is larger.

### (Use Condition Specifying Unit)

The use condition specifying unit 40 specifies the use conditions in a case in which the user executes the operation to use the first image. More specifically, the use condition specifying unit 40 specifies, for example, conditions such as the image quality of the user terminal that is the provision destination of the third image and the related information, the size of the display screen of the user terminal, or the print size.

### (Data Transmission Unit)

The data transmission unit 41 transmits the third image generated by the third image generation unit 36. Further, the data transmission unit 41 transmits the related information acquired by the related information acquisition unit 39.

More specifically, the data transmission unit 41 transmits the third image and the related information to the user terminal, the printer, or the like in which the third image or the related information is used, in a form corresponding to the use conditions specified by the use condition specifying unit 40.

### <<Present Image Processing Flow According to One Embodiment of Present Invention>>

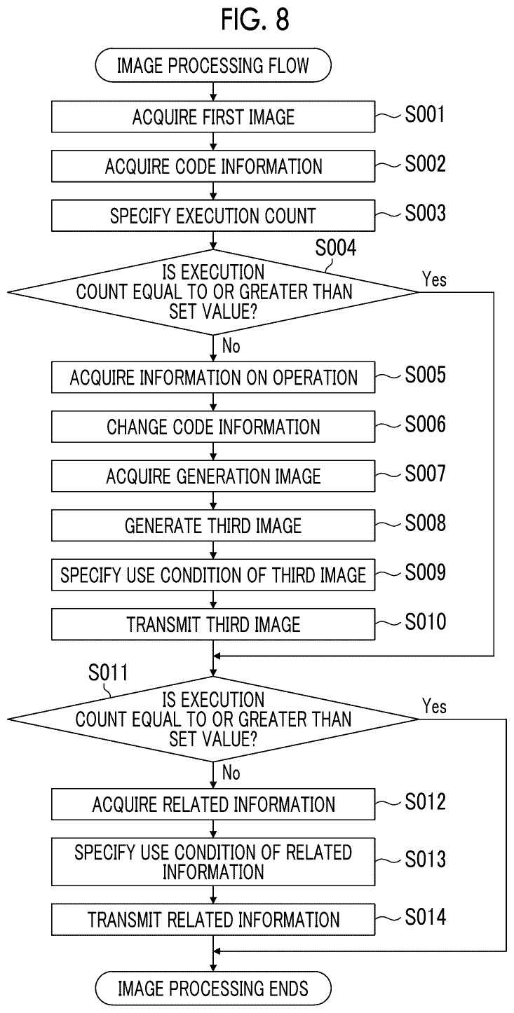

Next, the present image processing flow, which is a data processing flow using the image processing device 10 described above, will be described. The present image processing flow adopts the image processing method according to the embodiment of the present invention, and proceeds along the flow shown in FIG. 8. That is, each step in the flow shown in FIG. 8 corresponds to each element constituting the image processing method according to the embodiment of the present invention.

The flow shown in FIG. 8 is merely an example, and new steps may be added or the order of steps may be changed without departing from the gist of the present invention.

First, the user activates the image processing application installed on the user terminal 100, and a signal generated in conjunction with the activation of the application is transmitted to the server computer constituting the image processing device 10. The present image processing flow is started in response to the transmission of the signal.

First, the processor 21 acquires the first image including the code region in response to the operation executed by the user regarding the first image, more specifically, the operation of scanning the subject included in the first image, the operation of transmitting the first image to another user, or the operation of printing the first image (S001). After acquiring the first image, the processor 21 acquires the code information from the code region in the first image (S002).

Then, the processor 21 specifies the execution count indicating how many times the code information has been changed to date, based on the acquired code information (S003). The processor 21 determines whether or not the execution count indicating how many times the code information has been changed to date is equal to or greater than the second set value (S004). In a case in which the execution count is equal to or greater than the second set value, the processor 21 restricts the change of the code information. Specifically, the processor 21 skips steps S005 to S010, and does not execute the change of the code information.

In a case in which the execution count is less than the second set value, the processor 21 acquires the information related to the operation (S005). Specifically, the processor 21 acquires at least one of the information related to the operation that is a trigger for changing the code information, that is, the information related to the content of the operation by the user, the device that has received the operation by the user, or the user who has executed the operation.

Then, the processor 21 changes the code information based on the code information and the information related to the operation (S006). More specifically, the processor 21 updates, using the information on the operation, at least one of the execution count included in the code information, the execution time at which the code information has been changed, the content of the operation that is a trigger for changing the code information by the user, the information related to the device that has received the operation, or the information related to the user who has executed the operation, in the code information.

Then, the processor 21 acquires the generation image used for generating the third image (S007). The processor 21 acquires, more specifically, the second image included in the first image or the fourth image corresponding to the second image.

Then, the processor 21 generates the third image including the acquired generation image (second image or fourth image) and the code region based on the changed code information (S008).

Then, the processor 21 specifies the use conditions in a case in which the image related to the first image, that is, the third image is used (S009). More specifically, the processor 21 specifies the conditions such as the image quality of the user terminal using the third image, the size of the display screen of the user terminal, and the print size. After specifying the use conditions of the third image, the processor 21 transmits the third image to the user terminal or the printer in a form corresponding to the use conditions (S010).

Then, the processor 21 determines whether or not the execution count is equal to or greater than the first set value (S011). In a case in which the execution count is equal to or greater than the first set value, the processor 21 restricts the transmission of the related information. Specifically, the processor 21 skips steps S012 to S014, and does not transmit the related information.

In a case in which the execution count is less than the first set value, the processor 21 acquires the related information associated with the first image (S012). As described above, the related information may be the simple notification or may be the provision data. Then, the processor 21 specifies the use conditions in a case in which the related information is used (S013), and transmits the related information to the user terminal in a form corresponding to the use conditions (S014).

The present image processing flow ends at a point in time at which the series of processes described above ends.

### <<Effectiveness of One Embodiment of Present Invention>>

As described so far, the processor 21 acquires the first image including the code region, acquires the code information from the code region, and changes the code information in response to the operation by the user.

Accordingly, since the code information is changed each time the operation is executed by the user, the information corresponding to the execution count is accumulated in the code information. That is, as the execution count increases, the execution count is reflected in the code information.

As a result, the execution count after the increase can be specified from the code information, and the process corresponding to the specified execution count can be executed for the user.

For example, it is possible to provide the provision data corresponding to the execution count to the user by using the information corresponding to the execution count acquired from the code information. As a result, the user executes the operation for using the first image in order to acquire better provision data, and, as a result, it is possible to prompt the user to use the first image including the code region.

In addition, in the present embodiment, the code information is changed in accordance with the operation by the user.

As a result, the series of processes from the operation by the user to the change of the code information is smoothly executed, and thus it is possible to smoothly provide the user with the provision data corresponding to the execution count of the operation by the user. By smoothly acquiring the provision data, the user has an intention to acquire better provision data, and, as a result, it is possible to further prompt the user to use the first image including the code region.

In addition, the operation by the user is the operation of scanning the subject included in the first image. In addition, the operation by the user is the operation of printing the first image. In addition, the operation by the user is the operation of transmitting the first image to another user.

As a result, the code information is changed in response to the operation that is generally executed, and the user can acquire the provision data corresponding to the execution count of the operation by executing such a general operation. In this case, the user is motivated to execute the above-described operation in order to acquire better provision data, and, as a result, it is possible to further prompt the user to use the first image including the code region.

In addition, the code information includes the execution count indicating how many times the code information has been changed to date. In addition, in a case of changing the code information, the processor 21 updates the execution count included in the code information.

Accordingly, it is possible to provide the provision data corresponding to the execution count to the user, and the user executes the operation for using the first image in order to acquire better provision data, and, as a result, it is possible to prompt the user to use the first image including the code region.

Further, in a case of changing the code information, the processor 21 adds at least one of the information related to the device that has received the operation or the information related to the user to the code information.

Accordingly, it is possible to provide the provision data corresponding to the execution count for each device or each user.

Further, the processor 21 generates the third image including the second image included in the first image and the code region based on the changed code information.

It is possible to prompt the user to use the first image including the code region by acquiring the generated third image as the first image.

In addition, the code information includes the storage destination information for specifying the storage destination of the fourth image corresponding to the second image included in the first image. Further, the processor 21 acquires the fourth image stored in the storage destination based on the storage destination information.

As a result, for example, the user can use the fourth image corresponding to the second image.

Further, the processor 21 generates the third image including the fourth image and the code region based on the changed code information.

It is possible to prompt the user to use the first image including the code region by acquiring the generated third image as the first image.

In addition, the code information includes the history information related to the execution history in which the code information has been changed to date.

As a result, it is possible to provide the provision data corresponding to the history information to the user, and the user executes the operation for using the first image in order to acquire better provision data corresponding to the history information. As a result, it is possible to prompt the user to use the first image including the code region.

In addition, the history information includes at least one of the execution time at which the code information has been changed, the content of the operation by the user, or the device that has received the operation by the user.

Accordingly, for example, by referring to the execution time of the code information, it is possible to provide the provision data with a higher rank as the user has an earlier execution time, and the user is more likely to execute an operation for using the first image in order to acquire better provision data. As a result, it is possible to further prompt the user to use the first image including the code region.

Further, the processor 21 transmits the related information associated with the first image.

Accordingly, the user executes the operation for using the first image in order to acquire more related information. As a result, it is possible to prompt the user to use the first image including the code region.

In addition, the processor 21 specifies the execution count indicating how many times the code information has been changed to date, based on the code information. In addition, the processor 21 transmits the provision data corresponding to the execution count as the related information.

As a result, the user executes the operation for using the first image in order to acquire better provision data, and, as a result, it is possible to prompt the user to use the first image including the code region.

In addition, in a case in which the execution count is equal to or greater than the first set value, the processor 21 restricts the transmission of the related information.

As a result, the user attempts to use the first image in order to acquire the related information before the transmission of the related information is restricted. As a result, it is possible to effectively prompt the user to use the first image including the code region.

In addition, the processor 21 specifies the execution count indicating how many times the code information has been changed to date, based on the code information. In addition, the processor 21 restricts the change of the code information in a case in which the execution count is equal to or greater than the second set value.

As a result, the user attempts to use the first image before the change of the code information is restricted, for example, in a case in which the transmission of the related information is restricted in response to the restriction of the change of the code information. As a result, it is possible to effectively prompt the user to use the first image including the code region.

In addition, the processor 21 specifies the use conditions in a case in which the user executes the operation to use the first image. In addition, the processor 21 transmits the provision data that is associated with the first image and that corresponds to the use conditions.

As a result, the user is motivated to acquire the provision data, which is easy to use, again, and as a result, it is possible to further prompt the user to use the first image including the code region.

### Other Embodiments

In the image processing system S, the image processing device 10 may be configured by the server computer, but the present invention is not limited to this, and, for example, the image processing device according to the embodiment of the present invention may be configured by the user terminal.

Various processors are included in the image processing device according to the embodiment of the present invention and the processor provided in the image processing device. Examples of the various processors include a CPU which is a general-purpose processor that executes software (program) to function as various processing units.

Furthermore, the various processors include a programmable logic device (PLD) which is a processor of which a circuit configuration is changeable after manufacture, such as a field-programmable gate array (FPGA).

Furthermore, the various processors described above also include a dedicated electric circuit which is a processor of which a circuit configuration is specially designed for executing specific processing, such as an application-specific integrated circuit (ASIC).

The image processing device according to the embodiment of the present invention and one processing unit provided in the image processing device may be configured by one of the various processors described above, or may be configured by a combination of two or more processors of the same type or different types, for example, a combination of a plurality of FPGAs or a combination of an FPGA and a CPU.

Further, a plurality of functional units of the image processing device according to the embodiment of the present invention may be configured by one of the various processors, or two or more of the plurality of functional units may be configured by one processor.

In addition, as in the embodiments described above, a form may be adopted in which one processor is configured by a combination of one or more CPUs and software, and the processor functions as the plurality of functional units.

Further, for example, as represented by a system on a chip (SoC) or the like, a form may be adopted in which a processor that implements the functions of the entire system including the image processing device according to the embodiment of the present invention and the plurality of functional units in the image processing device with one integrated circuit (IC) chip is used. In addition, a hardware configuration of the various processors described above may be an electric circuit (circuitry) in which circuit elements, such as semiconductor elements, are combined.

### EXPLANATION OF REFERENCES

10: image processing device
100: user terminal
100A, 100B: terminal
11: database server
21: processor
22: memory
23: communication interface
24: storage device
31: first image acquisition unit
32: code information acquisition unit
33: operation information acquisition unit
34: code information change unit
35: generation image acquisition unit
36: third image generation unit
37: count specifying unit
38: restriction processing unit
39: related information acquisition unit
40: use condition specifying unit
41: data transmission unit
A, B: user
C1, C2, C3, C4, C5: code region
G1, G2, G3, G4, G5, M: image
N: network
P1, P2: printed matter
S: image processing system

What is claimed is:

1. An image processing device comprising:
a processor configured to:
acquire a first image including a code region;
acquire code information from the code region; and
change the code information in response to an operation by a user.

2. The image processing device according to claim 1,
wherein the code information is changed in accordance with the operation.

3. The image processing device according to claim 1,
wherein the operation is an operation of scanning a subject included in the first image.

4. The image processing device according to claim 1,
wherein the operation is an operation of printing the first image.

5. The image processing device according to claim 1,
wherein the operation is an operation of transmitting the first image to another user.

6. The image processing device according to claim 1,
wherein the code information includes an execution count indicating how many times the code information has been changed to date, and
the processor is configured to:
update the execution count included in the code information in a case of changing the code information.

7. The image processing device according to claim 1,
wherein the processor is configured to:
add at least one of information related to a device that has received the operation or information related to the user to the code information in a case of changing the code information.

8. The image processing device according to claim 1,
wherein the processor is configured to:
generate a third image including a second image included in the first image and the code region based on the changed code information.

9. The image processing device according to claim 1,
wherein the code information includes storage destination information for specifying a storage destination of a fourth image corresponding to a second image included in the first image, and
the processor is configured to:
acquire the fourth image stored in the storage destination, based on the storage destination information.

10. The image processing device according to claim 9,
wherein the processor is configured to:
generate a third image including the fourth image and the code region based on the changed code information.

11. The image processing device according to claim 1,
wherein the code information includes history information related to an execution history in which the code information has been changed to date.

12. The image processing device according to claim 11,
wherein the history information includes at least one of an execution time at which the code information has been changed, a content of the operation by the user, or a device that has received the operation by the user.

13. The image processing device according to claim 1,
wherein the processor is configured to:
transmit related information associated with the first image.

14. The image processing device according to claim 13,
wherein the processor is configured to:
specify an execution count indicating how many times the code information has been changed to date, based on the code information; and
transmit, as the related information, provision data corresponding to the execution count.

15. The image processing device according to claim 14,
wherein the processor is configured to:
restrict transmission of the related information in a case in which the execution count is equal to or greater than a first set value.

16. The image processing device according to claim 1,
wherein the processor is configured to:
specify an execution count indicating how many times the code information has been changed to date, based on the code information; and
restrict change of the code information in a case in which the execution count is equal to or greater than a second set value.

17. The image processing device according to claim 1,
wherein the processor is configured to:
specify use conditions in a case in which the user executes the operation to use the first image; and
transmit provision data that is associated with the first image and that corresponds to the use conditions.

18. An image processing method executed by a processor, the image processing method comprising:
a process of acquiring a first image including a code region;
a process of acquiring code information from the code region; and
a process of changing the code information in response to an operation by a user.

19. A non-transitory computer-readable recording medium on which a program causing a computer to execute each process included in the image processing method according to claim 18 is recorded.
